(19) United States
(12) Patent Application Publication
(10) Pub. No.: US 2023/0196442 A1
(43) Pub. Date: Jun. 22, 2023

(54) SELECTING METHODS TO ALLOCATE SHOPPERS FOR ORDER FULFILLMENT IN GEOGRAPHIC REGIONS BY AN ONLINE CONCIERGE SYSTEM BASED ON MACHINE-LEARNED EFFICIENCIES FOR DIFFERENT ALLOCATION METHODS

(71) Applicant: Maplebear Inc. (dba Instacart), San Francisco, CA (US)

(72) Inventors: Trace Levinson, San Francisco, CA (US); Aman Jain, Toronto (CA); Ji Chen, Mountain View, CA (US); Andrew Kephart, Lafayette, CA (US)

(21) Appl. No.: 17/556,936

(22) Filed: Dec. 20, 2021

(51) Int. Cl. G06Q 30/06

(52) U.S. Cl. CPC G06Q 30/0635

(57) ABSTRACT

An online concierge system allocates shoppers to different geographic regions at different times to fulfill orders received from users. The online concierge system uses different methods for adjusting allocation of shoppers to geographic regions, such as obtaining new shoppers or providing incentives to additional shoppers, based on estimated numbers of orders identifying different geographic regions. To account for costs to the online concierge system for allocating shoppers to geographic regions, the online concierge system trains multiple machine learned models to predict different efficiency metrics for methods for adjusting shopper allocation. Discrete samples are obtained from each efficiency metric, and samples that do not satisfy one or more constraints removed. From the remaining samples, a combination of samples for different methods for adjusting shopper allocation is selected to optimize a value to the online concierge system based on one or more criteria.

### BACKGROUND

This disclosure relates generally to allocating shoppers for fulfilling orders from an online concierge system to geographic regions, and more specifically to selecting methods for adjusting allocation of shoppers to geographic region accounting for efficiencies of different methods.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

Online concierge systems allocate shoppers to one or more geographic regions to fulfill orders identifying locations in different geographic regions. Many online concierge systems employ different methods to adjust a number of shoppers allocated to fulfill orders in a geographic region during a time interval based on an estimated number of orders to be fulfilled during the time interval. Example methods to adjust a number of shoppers allocated for fulfilling orders in a geographic region include obtaining new shoppers for the geographic region or providing incentives to existing shoppers to fulfill orders with locations in the geographic region during a time interval.

However, different methods for modifying allocation of shoppers to a geographic region during a time interval consume different amounts of resources of the online concierge system. Additionally, resources allocated to various methods of modifying allocation of shoppers to the geographic regions provide differing effectiveness in increasing shoppers allocated to the geographic region relative to the allocated resources. Certain methods of allocating shoppers to a geographic region provide diminishing effectiveness relative to the resources allocated to the methods. However, many conventional online concierge systems fail to account for varying effectiveness of shopper allocation methods relative to the resources allocated to the shopper allocation methods, resulting in inefficient resource allocation to different shopper allocation methods.

### SUMMARY

The online concierge system allocates shoppers for fulfilling orders in various geographic regions. In various embodiments, a number of shoppers allocated to a geographic region by the online concierge system is based on an estimated number of orders including locations within the geographic region to be fulfilled. The online concierge system 102 may allocate different numbers of shoppers to a geographic region during different time intervals, allowing the online concierge system to account for varying numbers of orders for fulfillment to locations within the geographic region over time. When a number of shoppers is allocated by the online concierge system to fulfill orders having locations in the geographic region, the online concierge system determines an estimated number of orders capable of being fulfilled by the allocated number of shoppers during a time interval. The online concierge system may determine the estimated number of orders capable of being fulfilled based on historical rates of order fulfillment by different numbers of shoppers and may account for characteristics of the geographic region when determining the estimated number of order capable of being fulfilled by the allocated number of shoppers.

The online concierge system compares the estimated number of orders to fulfill having locations within the geographic region during a time interval to the estimated number of orders capable of being fulfilled by the number of shoppers allocated to the geographic region during the time interval. When the online concierge system determines a geographic region has an estimated number of orders to fulfill during a time interval that exceeds and estimated number of orders capable of being fulfilled by the allocated number of shoppers during the time interval, the online concierge system increases a number of shoppers allocated to the identified geographic region during the time interval using one or more methods for adjusting shopper allocation to the geographic region during the time interval. An example method solicits or requests new shoppers to join the online concierge system for fulfilling orders in the identified geographic region, while another method allocates shoppers who are not assigned to a geographic region to fulfill orders with locations in the identified geographic region. Another example method provides one or more incentives (e.g., additional compensation) to shoppers to fulfill an increased number of orders with locations within the identified geographic region or for shoppers allocated to other geographic regions to also fulfill orders with locations within the identified geographic region. As the online concierge system expends resources when implementing one or more selected methods for adjusting shoppers allocated to a geographic region, the online concierge system accounts for an effectiveness of different methods in adjusting shoppers allocated to a geographic region relative to resources allocated to a method.

The online concierge system selects a specific number of samples from efficiency metrics for each of a plurality of methods for adjusting allocation of shoppers to a geographic region. The samples for an efficiency metric provide the online concierge system 102 with discrete combinations of estimated incremental numbers of shoppers corresponding to amounts of resources allocated to the model for adjusting shopper allocation corresponding to the efficiency metric. Each sample from an efficiency metric is compared to one or more threshold conditions, and the online concierge system removes samples that do not satisfy the threshold condition. For example, the online concierge system removes a sample including an amount of resources allocated to a model for adjusting allocation of shoppers corresponding to the sample that exceeds a maximum amount of resources. Removing the samples that do not satisfy the threshold condition creates a set of samples.

The set of samples are input to an optimization process, such as a mixed integer programming optimization process, where each sample of the set correspond to a decision variable having a first value if a sample is selected and a second, different, value if the sample is not selected. The optimization process selects different samples and generates values for each sample. The value of a sample is based on an amount of profit to the online concierge system for implementing a method for adjusting allocation of shoppers to a geographic region corresponding to the sample. In various embodiments, a value of a sample is determined based on a difference between a number of orders fulfilled in the geographic region during the time interval fulfilled when a method for adjusting allocation of shoppers corresponding to the sample is implemented and a number of orders capable of being fulfilled by the number of shoppers allocated to the geographic region during the time interval with no method for adjusting shopper allocation, with the number of orders fulfilled in the geographic region during the time interval fulfilled when a corresponding method for adjusting allocation of shoppers having an upper bound of the predicted number of order to fulfill in the geographic region during the time interval. The online concierge system may account for a cost of implementing the method for adjusting allocation of shoppers to the geographic region that accounts for a number of predicted orders capable of being fulfilled by implementing the method for adjusting allocation of shoppers that exceeds a predicted number of orders to be fulfilled in the geographic region during the time interval. Hence, in various embodiments, a value for a sample is determined as a difference between profit to the online concierge system for implementing the method for adjusting allocation of shoppers corresponding to the sample and a cost to the online concierge system of implementing the method for adjusting allotion of shoppers corresponding to the sample.

The online concierge system selects a combination of samples corresponding to efficiency metrics for different methods of adjusting allocation of shoppers to the geographic region having a maximum combination of corresponding values, subject to one or more optimization constraints. In various embodiments, the online concierge system selects a combination of samples having a maximum sum of their corresponding values that satisfies one or more optimization constraints. When determining an aggregate value of combinations of samples, the online concierge system selects one sample from each efficiency metric in various embodiments, with such a limitation of inclusion of a single sample for each method of adjusting allocation of shoppers in an evaluated combination of samples allows the online concierge system optimize allocation of resources across methods of adjusting allocation of shoppers capable of being used.

Example optimization constraints for selecting the combination of samples include a maximum amount of resources allocated to the geographic region, so a total amount of resources expended by the online concierge system to implement methods for adjusting shopper allocation to the geographic region is constrained to not exceed the maximum amount of resources allocated to the geographic region. The online concierge system may also maintain model-specific maximum resource allocations for different models for adjusting shopper allocation. For example, a model specific-maximum resource allocation specifies a maximum amount of resources allocated to a model for adjusting shopper allocation per incremental order predicted to be fulfilled in the geographic region during the time interval; hence, when selecting a sample, the online concierge system compares a ratio of an amount of resources allocated to the method for adjusting shopper allocation corresponding to the sample to a number of incremental orders predicted to be fulfilled in the geographic region during the time interval with the model for adjusting allocation of shoppers to the geographic region during the time interval corresponding to the model implemented. Hence, the online concierge system selects a combination of samples where each selected sample includes an amount of resources that does not exceed the model specific-maximum resource allocation for a method for adjusting shopper allocation corresponding to the selected sample of the set.

In various embodiments, the online concierge system identifies a plurality of geographic regions and obtains efficiency metrics for each of the plurality of methods for adjusting allocation of shoppers to each of the geographic regions. For each geographic region, the online concierge system selects the specific number of samples from each efficiency metric and removes samples that do not satisfy one or more threshold conditions in parallel, generating a set of samples for each geographic region. For each of the plurality of geographic regions, the online concierge system determines a value for each sample of the set of samples for a geographic region and selects a combination of samples having an optimum combination of their corresponding values, subject to one or more optimization criteria for the geographic region. Selecting a combination of samples for multiple geographic regions in parallel reduces latency for the online concierge system to optimally allocate resources to different methods for adjusting allocation of shoppers to different geographic regions during a time interval. Further, determining the optimal allocation of resources to different methods for adjusting allocation of shoppers for different geographic regions allows the online concierge system 102 to more accurately determine allocation of resources to different geographic regions, compared to allocating resources for multiple geographic regions in the aggregate.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for an online concierge system selecting resources for one or more methods for adjusting allocation of shoppers to one or more geographic regions, according to one embodiment.

FIG. 5 is a conceptual diagram showing differences in predicted order fulfillment when a method for adjusting shopper allocation is implemented, according to one embodiment.

FIG. 6 is a process flow diagram of a method for the online concierge system selecting resources for one or more methods for adjusting shoppers allocated to a geographic region for fulfilling orders, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

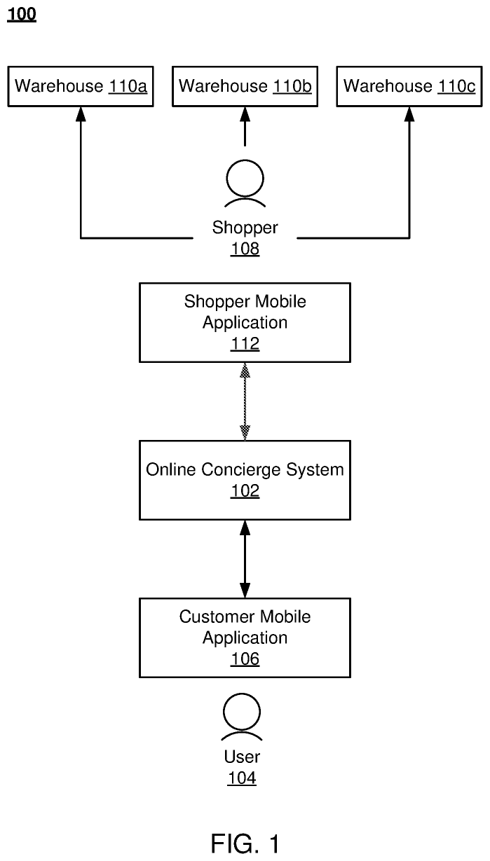

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

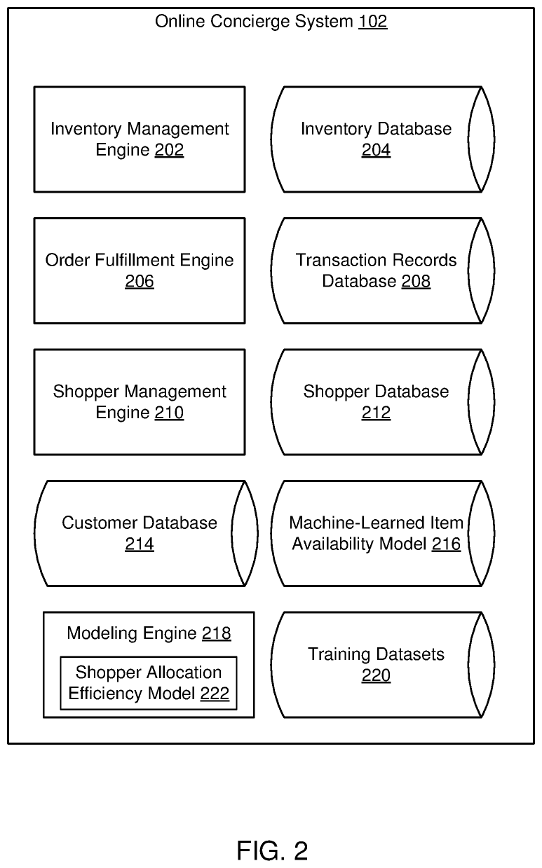

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

Additionally, the shopper management engine 210 allocates numbers of shoppers to different geographic regions at different time intervals to fulfilling orders. In various embodiments, a number of shoppers allocated to a geographic region by the shopper management engine 210 is based on an estimated number of orders including locations within the geographic region to be fulfilled. In various embodiments, the shopper management engine 102 includes an order estimation model that receives as input a geographic region and a time interval. Based on characteristics of prior orders received for the geographic region during the time interval, the order estimation model outputs an estimated number of orders for the geographic region during the time interval. To train the order estimation model, the shopper management engine 210 generates training data comprising a plurality of examples, with each example including a geographic region, a time interval, and contextual information for the geographic region and for the time interval. Each example of the training data is labeled with the number of orders received for fulfillment in the geographic region during the time interval. Hence, the shopper management engine 210 uses previously received orders as the labels for training the order estimation model, allowing the order estimation model to leverage historical information about order volumes received for different geographic regions during different time intervals

The shopper management engine 210 initializes a network comprising the order estimation model and applies the order estimation model to each of a plurality of examples of the training data. For an example of the training data, application of the order estimation model to an example generates an estimated number of orders to be fulfilled in a geographic region during the time interval of the example. The shopper management engine 210 determines an error term from a loss function based on a difference between the label applied to the example of the training data and the estimated number of orders to be fulfilled in a geographic region during the time interval of the example. The shopper management engine 210 repeatedly backpropagates the one or more error terms from the label applied to an example of the training data and the estimated number of orders to be fulfilled in a geographic region during the time interval of the example through layers of the network comprising the order estimation model. The backpropagation of the one or more error terms is repeated by the shopper management engine 210 until the one or more loss functions satisfy one or more criteria. In some embodiments, the shopper management engine 210 uses gradient descent or any other suitable process to minimize the one or more error terms in various embodiments. In response to the one or more loss functions satisfying the one or more criteria, the shopper management engine 210 stops backpropagation of the one or more error terms and stores the set of parameters for the layers of the network. For example, the shopper management engine 210 stores the weights of connections between nodes in the network as the set of parameters of the order prediction model in a non-transitory computer readable storage medium.

Additionally, the shopper management engine 210 determines a number of shoppers allocated to the geographic region during the time interval based on information received from shoppers identifying availability during different time interval and geographic regions selected by the shoppers. For example, the shopper management engine 210 obtains information from a shopper identifying geographic regions in which a shopper is capable of fulfilling orders during various time intervals. From the number of shoppers allocated to the geographic region during the time interval, the shopper management engine 210 determines an estimated number of orders capable of being fulfilled by the allocated number of shoppers during the time interval. The online concierge system 102 may determine the estimated number of orders capable of being fulfilled based on historical rates of order fulfillment by different numbers of shoppers and may account for characteristics of the geographic region when determining the estimated number of order capable of being fulfilled by the allocated number of shoppers.

In various embodiments, the shopper management engine 210 includes an order fulfillment model that receives as input a number of shoppers allocated to a geographic region, the geographic region, and a time interval and outputs an estimated number of orders capable of being fulfilled by the number of shoppers in the geographic region during the time interval. To train the order fulfillment model, the shopper management engine 210 generates training data comprising a plurality of examples, with each example including a geographic region, a time interval, contextual information for the geographic region and for the time interval, and a number of shoppers allocated to the geographic region. Each example of the training data is labeled with the number of orders in the geographic region fulfilled during the time interval by the number of shoppers allocated to the geographic region. Hence, the shopper management engine 210 uses orders previously fulfilled orders in the geographic region at different time interval as the labels for training the order estimation model, allowing the order fulfillment model to leverage historical information about fulfillment of orders in the geographic region by varying numbers of shoppers during different time intervals.

The shopper management engine 210 initializes a network comprising the order fulfillment model and applies the order fulfillment model to each of a plurality of examples of the training data. For an example of the training data, application of the order fulfillment model to an example generates an estimated number of orders capable of being fulfilled in a geographic region during a time interval of the example by a number of shoppers in the example allocated to the geographic region. The shopper management engine 210 determines an error term from a loss function based on a difference between the label applied to the example of the training data and the estimated number of orders capable of being fulfilled in the geographic region during the time interval of the example by the number of shoppers in the example allocated to the geographic region. The shopper management engine 210 repeatedly backpropagates the one or more error terms from the label applied to an example of the training data and the estimated number of orders capable of being fulfilled in the geographic region during the time interval of the example by a number of shoppers in the example allocated to the geographic region through layers of the network comprising the order fulfillment model. The backpropagation of the one or more error terms is repeated by the shopper management engine 210 until the one or more loss functions satisfy one or more criteria. In some embodiments, the shopper management engine 210 uses gradient descent or any other suitable process to minimize the one or more error terms in various embodiments. In response to the one or more loss functions satisfying the one or more criteria, the shopper management engine 210 stops backpropagation of the one or more error terms and stores the set of parameters for the layers of the network. For example, the shopper management engine 210 stores the weights of connections between nodes in the network as the set of parameters of the order fulfillment model in a non-transitory computer readable storage medium.

The shopper management engine 210 compares the estimated number of orders capable of being fulfilled by the allocated number of shoppers during the time interval to the estimated number of orders to fulfill in the time interval during the geographic region. In response to the estimated number of orders to fulfill in the time interval during the geographic region exceeding the estimated number of orders capable of being fulfilled by the allocated number of shoppers during the time interval, the shopper management engine 210 selects one or more methods for adjusting allocation of shoppers to the geographic region to increase a number of shoppers allocated to the geographic region. An example method for adjusting allocation of shoppers to the geographic region solicits or requests new shoppers to join the online concierge system for fulfilling orders in the identified geographic region, while another method for adjusting allocation of shoppers to the geographic region allocates shoppers who are not assigned to a geographic region to fulfil orders with locations in the identified geographic region. Another example method for adjusting allocation of shoppers to the geographic region provides one or more incentives (e.g., additional compensation) to shoppers to fulfill an increased number of orders with locations within the identified geographic region or for shoppers allocated to other geographic regions to also fulfill orders with locations within the identified geographic region.

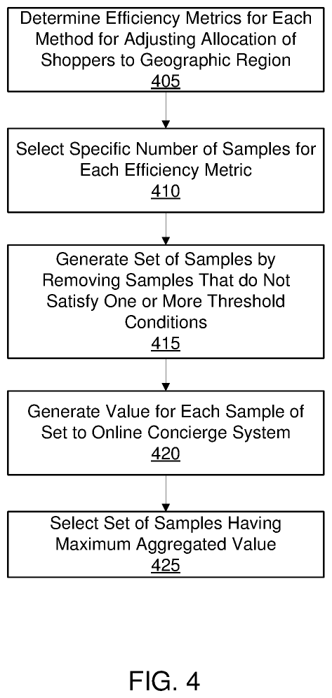

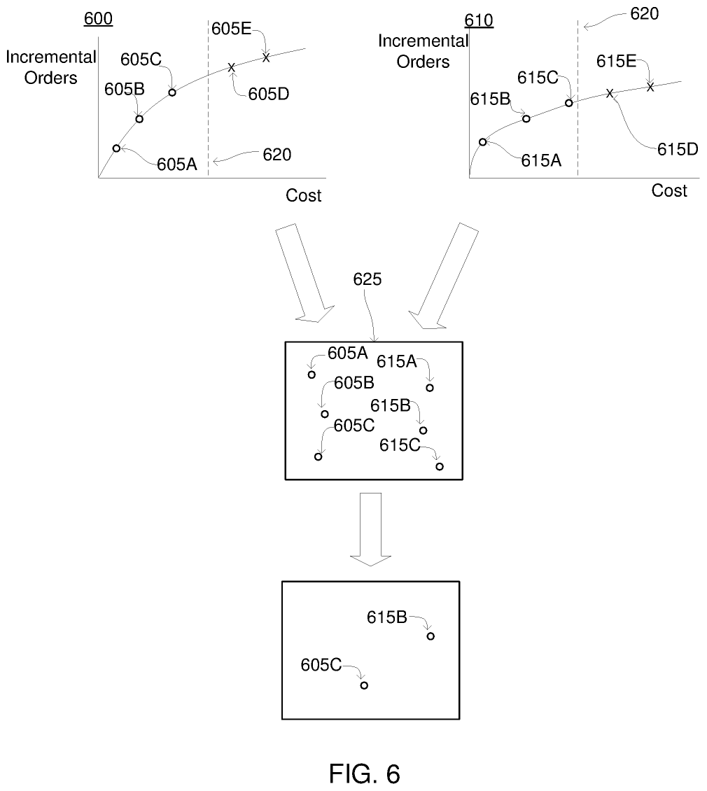

As the online concierge system 102 expends resources when implementing one or more selected methods for adjusting shoppers allocated to a geographic region, the shopper management engine 210 evaluates effectiveness of different methods for adjusting shoppers allocated to the geographic region relative to resources allocated to the different methods for adjusting shoppers allocated to the geographic region to determine how to optimally allocate resources to different methods for adjusting shoppers allocated to the geographic region. As further described below in conjunction with FIGS. 4-6, the shopper management engine 210 selects a set of samples including samples from each of a plurality of efficiency metrics, with each efficiency metric corresponding to a method for adjusting allocation of shoppers to a geographic region during a time interval. A sample identifies an incremental number of shoppers added to the geographic region by a method for adjusting allocation of shoppers to the geographic region and an amount of resources allocated to the method for adjusting allocation of shoppers to the geographic region. Each sample of the set satisfies a threshold condition, allowing the shopper management engine 210 to conserve computational resources by discounting certain samples. As further described below in conjunction with FIGS. 4 and 6, the shopper management engine 210 determines a value for each sample, with a value for a sample based on a profit to the online concierge system 102 for the number of incremental shoppers added to the geographic region by the sample relative to the amount of resources included to the sample and constrained by a difference between the estimated number of orders to fulfill in the geographic region during the time interval and the estimated number of orders capable of being fulfilled by the allocated number of shoppers during the time interval. Subject to one or more optimization constrains, the shopper management engine 210 selects a combination of samples, with the combination including a specific number of samples from each efficiency metric for a method for adjusting shoppers allocated to the geographic region during the time interval, resulting an optimal combination of values corresponding to the samples. IN various embodiments, the combination includes a single sample corresponding to each method for adjusting allocation of shoppers to the geographic region, allowing the order fulfillment engine to optimally allocate resources across each method for adjusting allocation of shoppers to the geographic region.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 includes one or more shopper allocation efficiency models 222, with a shopper allocation efficiency model corresponding to a method for adjusting allocation of shoppers to a geographic region. A shopper allocation efficiency model receives a geographic region, a time interval, characteristics of the geographic region and the time interval, and an amount of resources as input and outputting a number of incremental shoppers allocated to the geographic region during the time interval. To train a shopper allocation efficiency model the modeling engine 218 generates training data comprising a plurality of examples, with each example including a geographic region, a time interval, contextual information for the geographic region and for the time interval, and an amount of allocated resources. Each example of the training data is labeled with an incremental number of shoppers added to the geographic region during the time interval for the amount of allocated resources. Hence, the modeling engine 218 uses prior effects of a method for adjusting allocation of shoppers to geographic regions during time intervals when varying amounts of resources are allocated to the model for adjusting allocation of shoppers to the geographic region, allowing a shopper allocation efficiency model 222 to leverage historical information about prior changes in shoppers allocated to a geographic region during different time intervals with different amounts of resources.

The modeling engine 218 initializes a network comprising the shopper allocation efficiency model 222 and applies the shopper allocation efficiency model 222 to each of a plurality of examples of the training data. For an example of the training data, application of the shopper allocation efficiency model 222 to an example generates an estimated incremental number of shoppers added to the geographic region during the time interval of the example with the amount of resources in the example allocated to a method for adjusting allocation of shoppers to the geographic region. The modeling engine 218 determines an error term from a loss function based on a difference between the label applied to the example of the training data and the estimated incremental number of shoppers added to the geographic region during the time interval of the example with the amount of resources in the example allocated to the method for adjusting allocation of shoppers to the geographic region. The modeling engine repeatedly backpropagates the one or more error terms from the label applied to an example of the training data and the estimated incremental number of shoppers added to the geographic region during the time interval of the example with the amount of resources in the example allocated to the method for adjusting allocation of shoppers to the geographic region through layers of the network comprising the shopper allocation efficiency model 222. The backpropagation of the one or more error terms is repeated by the modeling engine 218 until the one or more loss functions satisfy one or more criteria. In some embodiments, the modeling engine 218 uses gradient descent or any other suitable process to minimize the one or more error terms in various embodiments. In response to the one or more loss functions satisfying the one or more criteria, the modeling engine 218 stops backpropagation of the one or more error terms and stores the set of parameters for the layers of the network. For example, the modeling engine 218 stores the weights of connections between nodes in the network as the set of parameters of the shopper allocation efficiency model 222 in a non-transitory computer readable storage medium. The modeling engine 218 applies the shopper allocation efficiency model 222 to different amounts of resources to generate one or more efficiency metrics, such as an efficiency curve, that identify increases in a number of shoppers allocated to a geographic region during a time interval for different amounts of resources allocated to a method for adjusting allocation of shoppers to the geographic region during the time interval.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

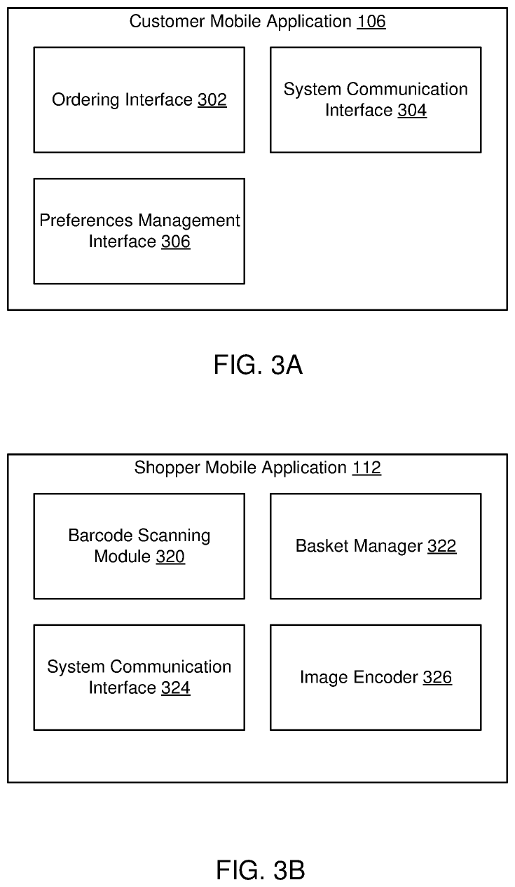

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Allocating Resources to One or More Methods for Adjusting Allocation of Shoppers to Geographic Regions

FIG. 4 is a flowchart of a method for an online concierge system 102 selecting resources for one or more methods for adjusting allocation of shoppers to one or more geographic regions. In various embodiments, the method includes different or additional steps than those described in conjunction with FIG. 4. Further, in some embodiments, the online concierge system 102 performs steps of the method in a different order than the order described in conjunction with FIG. 4.

The online concierge system 102 allocates shoppers for fulfilling orders in various geographic regions. In various embodiments, a number of shoppers allocated to a geographic region by the online concierge system 102 is based on an estimated number of orders including locations within the geographic region to be fulfilled. The online concierge system 102 may allocate different numbers of shoppers to a geographic region during different time intervals, allowing the online concierge system 102 to account for varying numbers of orders for fulfillment to locations within the geographic region over time. When a number of shoppers is allocated by the online concierge system 102 to fulfill orders having locations in the geographic region, the online concierge system 102 determines an estimated number of orders capable of being fulfilled by the allocated number of shoppers during a time interval. The online concierge system 102 may determine the estimated number of orders capable of being fulfilled based on historical rates of order fulfillment by different numbers of shoppers, and may account for characteristics of the geographic region when determining the estimated number of order capable of being fulfilled by the allocated number of shoppers.

The online concierge system 102 compares the estimated number of orders to fulfill having locations within the geographic region during a time interval to the estimated number of orders capable of being fulfilled by the number of shoppers allocated to the geographic region during the time interval. When the online concierge system 102 determines a geographic region has an estimated number of orders to fulfill during a time interval that exceeds and estimated number of orders capable of being fulfilled by the allocated number of shoppers during the time interval, the online concierge system 102 increases a number of shoppers allocated to the identified geographic region during the time interval using one or more methods for adjusting shopper allocation to the geographic region (also referred to as “methods for adjusting allocation of shoppers to the geographic region”) during the time interval. An example method for adjusting allocation of shoppers to the geographic region solicits or requests new shoppers to join the online concierge system for fulfilling orders in the identified geographic region, while another method for adjusting allocation of shoppers to the geographic region allocates shoppers who are not assigned to a geographic region to fulfil orders with locations in the identified geographic region. Another example method for adjusting allocation of shoppers to the geographic region provides one or more incentives (e.g., additional compensation) to shoppers to fulfill an increased number of orders with locations within the identified geographic region or for shoppers allocated to other geographic regions to also fulfill orders with locations within the identified geographic region. As the online concierge system 102 expends resources when implementing one or more selected methods for adjusting shoppers allocated to a geographic region, the online concierge system 102 accounts for an effectiveness of different methods for adjusting shoppers allocated to a geographic region relative to resources allocated to a method.

For each of a plurality of models for adjusting allocation of shoppers, the online concierge system 102 determines 405 efficiency metrics identifying a number of orders fulfilled from implementation of a model relative to an amount of resources allocated for implementing the model. In various embodiments, the efficiency metric for a method for adjusting allocation of shoppers is an efficiency curve identifying a number of orders fulfilled relative to an amount of resources consumed to implement the model. Hence, an efficiency metric determined 405 for a model identifies an incremental number of orders fulfilled from implementation of the model relative to an amount of resources consumed to implement the model. In various embodiments, the online concierge system 102 determines 405 the efficiency curve for a method of adjusting allocation of shoppers by applying one or more trained machine-learned models to characteristics of a geographic region. The machine-learned models may be trained from historical data describing changes in numbers of orders fulfilled in geographic regions when different amounts of resources were allocated to implement the model. The online concierge system 102 may maintain different trained machine-learned models for different methods for adjusting allocation of shoppers, allowing different machine-learned models to account for differences in characteristics that affect performance of different models for allocating shoppers.

For each efficiency metric for a model for allocating shoppers, the online concierge system 102 selects 410 a specific number of samples, with each sample including an incremental number of orders fulfilled, and an amount of resources consumed implementing the model. In various embodiments, the specific number of samples is a predetermined value stored by the online concierge system 102. For example, the online concierge system 102 determines 405 efficiency curves for each of a plurality of models for allocating shoppers and selects 410 twenty samples from each efficiency curve.

Additionally, the online concierge system 102 obtains threshold conditions for the models. For example, one or more threshold conditions specify a maximum amount of resources allocated for implementing a model for allocating shoppers. As an example, a threshold condition specifies a maximum amount for the online concierge system 102 to spend on implementing a model for allocating shoppers. The online concierge system 102 may obtain different threshold conditions for each model or may obtain one or more threshold conditions applied to multiple models for allocating shoppers. As another example, one or more conditions specify a minimum amount of resources to allocate for implementing one or more models for allocating shoppers.

The online concierge system 102 compares each sample of efficiency metrics for each model for allocating shoppers to the threshold conditions and removes 415 samples that do not satisfy one or more threshold conditions, resulting in a set of samples satisfying the threshold conditions. For example, a threshold condition specifies a maximum amount of a resource allocated for implementing a model for allocating shoppers, and the online concierge system 102 removes 415 samples that include an amount of the resource allocated for implementing a model for allocating shoppers that exceeds the maximum amount specified by the threshold condition. As an example, each sample includes an incremental number of orders fulfilled when a model for allocating shoppers is implemented and a cost for implementing the model for allocating shoppers corresponding to the incremental number of orders and a threshold condition specifies a maximum budget for implementing the model for allocating shoppers; hence, the online concierge system 102 removes 415 samples having a cost for implementing a model for allocating shoppers that exceeds the maximum budget. This allows the online concierge system 102 to conserve computational resources by discarding samples that to not satisfy one or more of the conditions from further evaluation.

The online concierge system 102 generates 420 a value for each sample of the set of samples and selects 425 a combination of samples having an optimum combination of their corresponding values, subject to one or more optimization criteria. In various embodiments, the online concierge system 102 selects 425 the one or more samples of the set through mixed integer programming optimization, where each sample of the set corresponding to a decision variable having a first value if the sample of the set is selected and a second, different, value if the sample of the set is not selected. In various embodiments, to generate 420 the value of a sample of the set of samples, the online concierge system 102 determines a product of a profit per order fulfilled during a time interval in the geographic region and an estimated number of incremental orders predicted to be fulfilled in the geographic region during the time interval with the method for adjusting shopper allocation corresponding to the sample of the set implemented and determines a cost to the online concierge system 102 from allocating the shoppers to the geographic region by implementing the method for adjusting allocation of shoppers. In various embodiments, the online concierge system 102 determines a difference between an estimated number of orders to be fulfilled in the geographic region during the time interval with the method for adjusting shopper allocation corresponding to the sample of the set implemented and the estimated number of orders to be fulfilled in the geographic region during the time interval. To determine the cost, the online concierge system 102 subtracts the determined distance from an estimated number of incremental orders capable of being fulfilled by shoppers allocated to the geographic region during the time interval by the method corresponding to the sample of the set for allocating shoppers. The online concierge system 102 generates a value for a sample as a difference between the determined product of a profit per order fulfilled during a time interval in the geographic region and a number of orders estimated to be fulfilled in the geographic region during the time interval for the sample of the set and the determined cost. Hence, the value for the sample measures a profit to the online concierge system 102 for implementing the method for adjusting allocation of shoppers corresponding to the sample that accounts for a cost to the online concierge system 102 for the method for adjusting allocation of shoppers (also referred to as a “method for adjusting shopper allocation”) corresponding to the sample resulting in a capacity for fulfilling orders that exceeds the predicted number of orders to be fulfilled for locations in the geographic region that during the time interval. In various embodiments, when determining a product of a profit per order fulfilled during a time interval in the geographic region and an incremental number of orders predicted to be fulfilled in the geographic region during the time interval with the method for adjusting shopper allocation corresponding to the sample of the set implemented, the online concierge system 102 constrains the incremental number of orders predicted to be fulfilled in the geographic region during the time interval with the method for adjusting shopper allocation corresponding to the sample of the set implemented to not exceed a difference between an estimated number of orders to be fulfilled in the geographic region during the time interval and an estimated number of orders capable of being fulfilled by shoppers allocated to the geographic region during the time interval without implementing one or more methods for adjusting shopper allocation. Such a constraint limits the online concierge system 102 to evaluating a method for adjusting shopper allocation for those orders that would have been unfulfilled in the geographic region during the time interval without accounting for fulfillment of orders in excess of the predicted number of orders to be fulfilled in the geographic region during the time interval.

In some embodiments, the online concierge system 102 applies a weight to the difference between the determined product of a profit per order fulfilled during a time interval in the geographic region and a number of orders estimated to be fulfilled in the geographic region during the time interval for a sample of the set and the determined cost when generating 420 the value for the sample. The weight based on a confidence for the time interval in which the method for adjusting the allocation of shoppers to the geographic region is applied, which accounts for a measure of uncertainty in the efficiency metric. In various embodiments, the confidence decreases as a length of the time interval increases, with the weigh directly related to the confidence for the time interval.

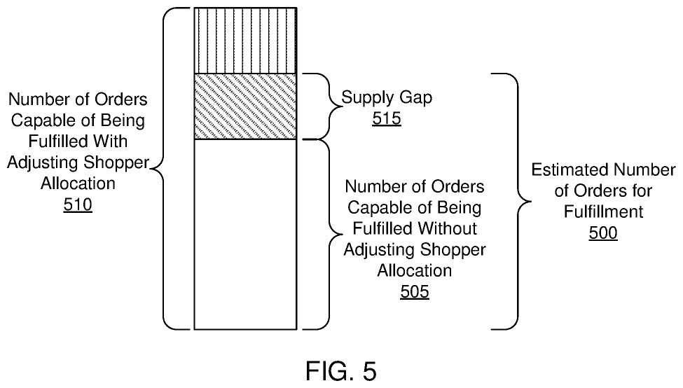

FIG. 5 is a conceptual diagram showing differences in predicted order fulfillment when a method for adjusting shopper allocation is implemented. In the example shown by FIG. 5, the online concierge system 102 estimates a number 500 of orders to be fulfilled in a geographic region during a time interval. Additionally, the online concierge system 102 allocates a number of shoppers to the geographic region during the time interval. The number of shoppers allocated to the geographic region during the time interval is based on a number of shoppers who previously fulfilled orders to locations in the geographic region and shoppers who previously indicated a capability to fulfill orders in the geographic region. The online concierge system 102 determines an estimated number 505 of orders capable of being fulfilled in the geographic region during the time interval from the number of shoppers allocated to the geographic region during the time interval. In various embodiments, the online concierge system 102 applies one or more trained machine learning models to characteristics of the geographic region and to the number of shoppers allocated to the geographic region to determine the estimated number 505 of orders capable of being fulfilled by the number of shoppers allocated to the geographic region.

When the estimated number 500 of orders for fulfillment in the geographic region during the time interval exceeds the estimated number of orders 505 capable of being fulfilled by the number of shoppers allocated to the geographic region, the online concierge system 102 evaluates one or more models for adjusting shopper allocation to increase a number of shoppers allocated to the geographic region during the time interval. To evaluate a method for adjusting shopper allocation to the geographic region during the time interval, the online concierge system 102 determines an estimated number 510 of orders capable of being fulfilled by the adjusted number of shoppers allocated to the geographic region during the time interval. As the adjusted number of shoppers allocated to the geographic region during the time interval may result in the estimated number 510 of orders capable of being fulfilled exceeding the estimated 500 number of orders for fulfillment in the geographic region during the time interval, the online concierge system 102 limits evaluation of the method for adjusting allocation of shoppers to the geographic region during the time interval to orders in a supply gap 515 that is a difference between the estimated number 500 of orders for fulfillment in the geographic area during the time interval and the estimated number of orders capable of being fulfilled in the geographic region during the time interval without adjusting allocation of shoppers to the geographic region during the time interval. This allows the online concierge system 102 to evaluate effectiveness of the method for adjusting shopper allocation to remedying the supply gap 515.

Referring back to FIG. 4, the online concierge system 102 accounts for additional optimization constraints when selecting 425 the one or more samples of the set. For example, the online concierge system 102 maintains a maximum amount of resources allocated to the geographic region, so a total amount of resources expended by the online concierge system 102 to implement methods for adjusting shopper allocation to the geographic region is constrained to not exceed the maximum amount of resources allocated to the geographic region. Additionally, the online concierge system 102 may maintain model-specific maximum resource allocations for different models for adjusting shopper allocation. For example, a model specific-maximum resource allocation specifies a maximum amount of resources allocated to a model for adjusting shopper allocation per incremental order predicted to be fulfilled in the geographic region during the time interval; hence, when selecting 425 a sample, the online concierge system 102 compares a ratio of an amount of resources allocated to the method for adjusting shopper allocation corresponding to the sample to a number of incremental orders predicted to be fulfilled in the geographic region during the time interval with the model for adjusting allocation of shoppers to the geographic region during the time interval corresponding to the model implemented. The online concierge system 102 discards samples where the comparison indicates the ratio exceeds the model specific-maximum resource allocation. Hence, when selecting 425 one or more samples, the online concierge system 102 selects 425 samples where each selected sample includes an amount of resources that does not exceed the model specific-maximum resource allocation for a method for adjusting shopper allocation corresponding to the selected sample of the set. In various embodiments, the online concierge system 102 maintains any suitable optimization constraints for use when selecting 425 the one or more samples of the set.

In various embodiments, the online concierge system 102 groups samples of the set based on corresponding methods for adjusting shopper allocation, with different groups corresponding to different methods for adjusting shopper allocation. When selecting 425 the one or more samples of the set, the online concierge system 102 selects a specific number of samples from each group having a maximum combined value. For example, the online concierge system 102 selects 425 a combination of samples that includes a single sample from each group with a maximum sum of values corresponding to the samples of the group. Such a constraint allows the online concierge system 102 to evaluate the sum of values for different combinations of samples from each group of the set of samples, allowing evaluation of different combinations of resources allocated to different methods for adjusting shopper allocation to the geographic region during the time interval. As each sample includes an incremental number of orders fulfilled and an amount of resources consumed implementing the model, the selected 425 combination of samples from each group identifies an optimal amount of resources for consumption by different methods for adjusting shopper allocation that maximizes a sum of values for different methods of adjusting shoppers allocation that are determined as the difference between the determined product of a profit per order fulfilled during a time interval in the geographic region and a number of orders predicted to be fulfilled in the geographic region during the time interval for the sample of the set and the determined cost, as further described above.

In various embodiments, the online concierge system 102 identifies a plurality of geographic regions and obtains 405 efficiency metrics for each of the plurality of methods for adjusting allocation of shoppers to each of the geographic regions. For each geographic region, the online concierge system 102 selects 410 the specific number of samples from each efficiency metric and removes 415 samples that do not satisfy one or more threshold conditions in parallel, generating a set of samples for each geographic region. For each of the plurality of geographic regions, the online concierge system 102 generates 420 a value for each sample of the set of samples for a geographic region and selects 425 a combination of samples having an optimum combination of their corresponding values, subject to one or more optimization criteria for the geographic region. Selecting a combination of samples for multiple geographic regions in parallel, as further described above in conjunction with FIG. 4 reduces latency for the online concierge system 102 to optimally allocate resources to different methods for adjusting allocation of shoppers to different geographic regions during a time interval. Further, determining the optimal allocation of resources to different methods for adjusting allocation of shoppers for different geographic regions allows the online concierge system 102 to more accurately determine allocation of resources to different geographic regions, compared to allocating resources for multiple geographic regions in the aggregate.

FIG. 6 is a process flow diagram of one embodiment of a method for the online concierge system 102 selecting resources for one or more methods for adjusting shoppers allocated to a geographic region for fulfilling orders. For purposes of illustration, FIG. 6 depicts two methods for adjusting allocation of shoppers for fulfilling orders in a geographic region. However, any suitable number of methods for adjusting allocation of shoppers for fulfilling orders in a geographic region may be evaluated by the online concierge system 102.

In response to determining an estimated number of orders to be fulfilled in a geographic region during a time interval exceeds an estimated number of orders capable of being fulfilled by shoppers allocated to the geographic region during the time interval, the online concierge system obtains efficiency metric 600 for a method for adjusting allocation of shoppers and efficiency metric 605 for an additional method for adjusting allocation of shoppers. Efficiency metric 600 and efficiency metric 600 each identify an estimated incremental number of additional orders capable of being fulfilled for different amounts of resources allocated to the method for adjusting shopper allocation and to the additional method for adjusting shopper allocation, respectively. For example, efficiency metric 600 identifies an estimated incremental number of additional shoppers capable of being fulfilled when the method for adjusting allocation of shoppers is implemented corresponding to an amount of resources allocated to the method for adjusting allocation of shoppers; similarly, efficiency metric 605 identifies an estimated incremental number of additional shoppers capable of being fulfilled when the additional method for adjusting allocation of shoppers is implemented corresponding to an amount of resources allocated to the additional method for adjusting allocation of shoppers.

The online concierge system 102 selects a specific number of samples from efficiency metric 600 and selects the specific number of samples from efficiency metric 605. In various embodiments, the online concierge system 102 selects a specific number of samples from efficiency metric 600 and from efficiency metric 605. In the example of FIG. 6, the online concierge system selects samples 605A, 605B, 605C, 605D, 605E (also referred to individually and collectively using reference number 605) from efficiency metric 600 and selects samples 615A, 615B, 615C, 615D, 615D (also referred to individually and collectively using reference number 615) from efficiency metric 610. Hence, samples 605 and samples 615 provide the online concierge system 102 with discrete combinations of estimated incremental numbers of shoppers corresponding to amounts of resources allocated to the model for adjusting shopper allocation and to the additional model for adjusting shopper allocation, respectively.

Each of samples 605 and samples 615 are compared to a threshold condition 620, and the online concierge system 102 removes samples 605 or samples 615 that do not satisfy the threshold condition. In the example of FIG. 6, the threshold condition 620 specifies a maximum amount of resources allocated. Based on the comparison, the online concierge system 102 removes samples 605D and 605, as they correspond to amounts of resources that exceed the threshold condition 620. Similarly, the online concierge system 102 removes samples 615D and 615E, which also correspond to amounts of resources that exceed the threshold condition 620. In various embodiments, a common threshold condition 620 is used for samples 605 from the model for adjusting shopper allocation and for samples 615 from the additional model for adjusting shopper allocation. However, in other embodiments, different threshold conditions 602 may be used for samples 605 and for samples 615, allowing the online concierge system 102 to maintain different threshold conditions 620 for different models for adjusting shopper allocation.

The remaining samples, samples 605A-C and samples 615A-C are input to an optimization process 625, such as a mixed integer programming optimization process, where each of sample 605A-C and sample 615A-C correspond to a decision variable having a first value if a sample is selected and a second, different, value if the sample is not selected. As further described above in conjunction with FIG. 4, the optimization process 625 uses this method to select different samples and generate a value to the online concierge system 102 for implementing one or more methods for adjusting allocation of shoppers with different amounts of resources that correspond to a sample. As further described above in conjunction with FIG. 4, the online concierge system 102 generates a value for each of sample 605A-C and sample 615A-C. In various embodiments, to determine the value for sample 605A-C or for sample 615A-C, the online concierge system 102 determines an amount of profit to the online concierge system 102 for sample 605A-C or sample 615A-C based on a difference between a number of orders fulfilled in the geographic region during the time interval fulfilled when a corresponding method for adjusting allocation of shoppers is implemented and the number of orders capable of being fulfilled by the number of shoppers allocated to the geographic region during the time interval with no method for adjusting shopper allocation, with the number of orders fulfilled in the geographic region during the time interval fulfilled when a corresponding method for adjusting allocation of shoppers having an upper bound of the predicted number of order to fulfill in the geographic region during the time interval. The online concierge system 102 similarly determines a cost for sample 605A-C or for sample 615A-C based on a difference between a predicted number of orders to be fulfilled in the geographic region during the time interval with the method for adjusting shopper allocation corresponding to sample 605A-C or to sample 615A-C implemented and the predicted number of orders to be fulfilled in the geographic region during the time interval. The online concierge system 102 determines the value of sample 605A-C or of sample 615A-C as a difference between the amount of profit for sample 605A-C or sample 615A-C and the corresponding cost of sample 605A-C or of sample 615A-C.

The online concierge system 102 selects a sample from samples 605A-C and a sample from samples 615A-C that results in a maximum combination of corresponding values. In the example of FIG. 6, the online concierge system 102 selects sample 605C and sample 615B, as a sum of a value for sample 605C and a value for sample 615B results in a maximum aggregate value of combinations of samples 605A-C and samples 615A-C. The selection of sample 605C and sample 615B indicates allocation of the amount of resources specified by sample 605C to the method for allocating shoppers to the geographic region during the time interval and allocation of the amount of resources specified by sample 615B to the additional method for allocating shoppers to the geographic region during the time interval. When determining an aggregate value of combinations of samples 605, 615, the online concierge system 102 selects one of sample 605A-C and one of sample 615A-C to include in each combination. Such a limitation of inclusion of a single sample for each method of adjusting allocation of shoppers in an evaluated combination of samples allows the online concierge system 102 optimize allocation of resources across methods of adjusting allocation of shoppers capable of being used. As further described above in conjunction with FIG. 4, the online concierge system 102 may account for one or more optimization constraints with selecting a combination of samples 605A-C and samples 615A-C, limiting selection to combinations of one of samples 605A-C and one of samples 615A-C that satisfy the one or more optimization constraints.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
determining, by an online concierge system, an estimated number of orders to fulfill in a geographic region during a time interval;
determining an estimated number of orders capable of being fulfilled by a number of shoppers allocated to the geographic region during the time interval;
in response to determining the estimated number of orders to fulfill in the geographic region during the time interval exceeds the estimated number of orders capable of being fulfilled by the number of shoppers allocated to the geographic region during the time interval:
obtaining efficiency metrics for each of a plurality of methods for adjusting allocation of shoppers to the geographic region, each efficiency metric identifying numbers of incremental orders capable of being fulfilled by implementing a method for adjusting allocation of shoppers to the geographic region for different amounts of resources allocated to the method for adjusting allocation of shoppers to the geographic region;
selecting a specific number of samples from each efficiency metric, each sample including a of incremental orders capable of being fulfilled by implementing a method for adjusting allocation of shoppers to the geographic region corresponding to the sample and an amount of resources allocated to the method for adjusting allocation of shoppers to the geographic region corresponding to the sample;
generating a set of samples by removing samples that do not satisfy one or more threshold conditions;
generating a value of each sample of the set, the value of the sample based on a difference between the amount of profit from an increased number of estimated orders capable of being fulfilled by implementing the method for adjusting allocation of shoppers corresponding to the sample and a cost of implementing the method for adjusting allocation of shoppers corresponding to the sample; and
selecting a combination of samples of the set having a maximum combined value subject to one or more optimization criteria, the combination of samples including a single sample corresponding to each of the plurality of methods for allocation shoppers.

2. The method of claim 1, wherein generating the value of each sample of the set comprises:
determining a product of a profit per estimated order fulfilled during the time interval in the geographic region and an estimated number of incremental orders predicted to be fulfilled in the geographic region during the time interval with the method for adjusting allocation of shoppers to the geographic region corresponding to the sample of the set implemented;
determining a cost to the online concierge system for allocating shoppers to the geographic region by implementing the method for adjusting allocation of shoppers to the geographic region corresponding to the sample of the set; and
determining the value of the sample of the set as a difference between the product and the cost.

3. The method of claim 2, wherein determining the cost to the online concierge system for allocating the shoppers to the geographic region by implementing the method for adjusting allocation of shoppers to the geographic region corresponding to the sample of the set comprises:
determining a difference between an estimated incremental number of orders to be fulfilled in the geographic region during the time interval with the method for adjusting allocation of shoppers to the geographic region corresponding to the sample of the set implemented and the predicted number of orders to be fulfilled in the geographic region during the time interval; and
determining the cost by subtracting the difference from an estimated number of incremental orders predicted to be fulfilled in the geographic region during the time interval with the method for adjusting allocation of shoppers to the geographic region corresponding to the sample of the set implemented.

4. The method of claim 2, wherein determining the value of the sample of the set as the difference between the product and the cost comprising:
determining the value of the sample of the set by applying a weight to the difference between the product and the cost, the weight based on a confidence for the time interval.

5. The method of claim 2, wherein the predicted number of orders to be fulfilled in the geographic region during the time interval with the method for adjusting allocation of shoppers to the geographic region corresponding to the sample of the set implemented does not exceed a difference between the estimated number of orders to be fulfilled in the geographic region during the time interval and the estimated number of orders capable of being fulfilled by the number of shoppers allocated to the geographic region during the time interval.

6. The method of claim 1, wherein selecting the combination of samples of the set having a maximum combined value subject to one or more optimization criteria comprises:
selecting the combination of samples of the set having a maximum combined value with a total amount of resources for implementing the methods for adjusting allocation of shoppers to the geographic region not exceeding a maximum amount of resources allocated to the geographic region.

7. The method of claim 1, wherein the combination of samples of the set having the maximum combined value subject to one or more optimization criteria comprises:
selecting samples of the set where each selected sample of the set includes an amount of resources allocated to the method for adjusting allocation of shoppers to the geographic region that does not exceed a model-specific maximum resource allocation for the method for adjusting allocation of shoppers to the geographic region corresponding to the selected sample of the set.

8. A computer program product comprising a non-transitory computer readable storage medium having instructions encoded thereon that, when executed by a processor, cause the processor to:
determine, by an online concierge system, an estimated number of orders to fulfill in a geographic region during a time interval;
determine an estimated number of orders capable of being fulfilled by a number of shoppers allocated to the geographic region during the time interval;
in response to determining the estimated number of orders to fulfill in the geographic region during the time interval exceeds the estimated number of orders capable of being fulfilled by the number of shoppers allocated to the geographic region during the time interval:
obtain efficiency metrics for each of a plurality of methods for adjusting allocation of shoppers to the geographic region, each efficiency metric identifying numbers of incremental orders capable of being fulfilled by implementing a method for adjusting allocation of shoppers to the geographic region for different amounts of resources allocated to the method for adjusting allocation of shoppers to the geographic region;
select a specific number of samples from each efficiency metric, each sample including a of incremental orders capable of being fulfilled by implementing a method for adjusting allocation of shoppers to the geographic region corresponding to the sample and an amount of resources allocated to the method for adjusting allocation of shoppers to the geographic region corresponding to the sample;
generate a set of samples by removing samples that do not satisfy one or more threshold conditions;
generate a value of each sample of the set, the value of the sample based on a difference between the amount of profit from an increased number of estimated orders capable of being fulfilled by implementing the method for adjusting allocation of shoppers corresponding to the sample and a cost of implementing the method for adjusting allocation of shoppers corresponding to the sample; and
select a combination of samples of the set having a maximum combined value subject to one or more optimization criteria, the combination of samples including a single sample corresponding to each of the plurality of methods for allocation shoppers.

9. The computer program product of claim 8, wherein generate the value of each sample of the set comprises:
determine a product of a profit per estimated order fulfilled during the time interval in the geographic region and an estimated number of incremental orders predicted to be fulfilled in the geographic region during the time interval with the method for adjusting allocation of shoppers to the geographic region corresponding to the sample of the set implemented;
determine a cost to the online concierge system for allocating shoppers to the geographic region by implementing the method for adjusting allocation of shoppers to the geographic region corresponding to the sample of the set; and
determine the value of the sample of the set as a difference between the product and the cost.

10. The computer program product of claim 9, wherein determine the cost to the online concierge system for allocating the shoppers to the geographic region by implementing the method for adjusting allocation of shoppers to the geographic region corresponding to the sample of the set comprises:
determine a difference between an estimated incremental number of orders to be fulfilled in the geographic region during the time interval with the method for adjusting allocation of shoppers to the geographic region corresponding to the sample of the set implemented and the predicted number of orders to be fulfilled in the geographic region during the time interval; and
determine the cost by subtracting the difference from an estimated number of incremental orders predicted to be fulfilled in the geographic region during the time interval with the method for adjusting allocation of shoppers to the geographic region corresponding to the sample of the set implemented.

11. The computer program product of claim 9, wherein determine the value of the sample of the set as the difference between the product and the cost comprising:
determine the value of the sample of the set by applying a weight to the difference between the product and the cost, the weight based on a confidence for the time interval.

12. The computer program product of claim 9, wherein the predicted number of orders to be fulfilled in the geographic region during the time interval with the method for adjusting allocation of shoppers to the geographic region corresponding to the sample of the set implemented does not exceed a difference between the estimated number of orders to be fulfilled in the geographic region during the time interval and the estimated number of orders capable of being fulfilled by the number of shoppers allocated to the geographic region during the time interval.

13. The computer program product of claim 8, wherein select the combination of samples of the set having a maximum combined value subject to one or more optimization criteria comprises:
select the combination of samples of the set having a maximum combined value with a total amount of resources for implementing the methods for adjusting allocation of shoppers to the geographic region not exceeding a maximum amount of resources allocated to the geographic region.

14. The computer program product of claim 8, wherein the combination of samples of the set having the maximum combined value subject to one or more optimization criteria comprises:
select samples of the set where each selected sample of the set includes an amount of resources allocated to the method for adjusting allocation of shoppers to the geographic region that does not exceed a model-specific maximum resource allocation for the method for adjusting allocation of shoppers to the geographic region corresponding to the selected sample of the set.
